(19) United States
(12) Patent Application Publication
(10) Pub. No.: US 2026/0252820 A1
(43) Pub. Date: Aug. 27, 2026

(54) EXTRACTION APPARATUS, GENERATION APPARATUS, EXTRACTION METHOD, GENERATION METHOD, AND PROGRAM

(71) Applicant: NTT, Inc., Tokyo (JP)

(72) Inventors: Katsuki CHOSA, Tokyo (JP); Makoto MORISHITA, Tokyo (JP); Masaaki NAGATA, Tokyo (JP)

(21) Appl. No.: 18/879,314

(22) PCT Filed: Jun. 30, 2022
(86) PCT No.: PCT/JP2022/026406

§ 371 Date: Dec. 27, 2024

(51) Int. Cl. G06F 40/58; G06F 40/242; G06F 40/55

(52) U.S. Cl. CPC G06F 40/58; G06F 40/242; G06F 40/55

(57) ABSTRACT

In an extraction apparatus, there is included a division unit that divides each of first information in a dictionary that is a set of a pair of the first information and second information and a first sequence into unit information, and a constraint information extraction unit that extracts the second information corresponding to the first information matching unit information of the first sequence from the dictionary as constraint information used for generating a second sequence on a basis of the first sequence.

### TECHNICAL FIELD

The present invention relates to the technical field of machine translation.

### BACKGROUND ART

Translation with a constraint for the purpose of including all specified words/phrases (constraint words/phrases) when a sentence in a certain domain is converted into another domain (for example, another language) is referred to as “lexically constrained machine translation”. Lexically constrained machine translation is a particularly important technology in translation of patent/legal/technical documents and the like, where consistency is required, since lexically constrained machine translation can unify translations for specific words.

### CITATION LIST

### Non Patent Literature

Non Patent Literature 1: Chen, G., Chen, Y., and Li, V. O. (2021). “Lexically Constrained Neural Machine Translation with Explicit Alignment Guidance.” Proceedings of the AAAI Conference on Artificial Intelligence.
Non Patent Literature 2: Matt Post and David Vilar. 2018. Fast Lexically Constrained Decoding with Dynamic Beam Allocation for Neural Machine Translation. In Proceedings of the 2018 Conference of the North American Chapter of the Association for Computational Linguistics: Human Language Technologies, Volume 1 (Long Papers), pages 1314-1324, New Orleans, Louisiana. Association for Computational Linguistics

### SUMMARY OF INVENTION

### Technical Problem

Translation of documents in a domain including many proper nouns such as patent specifications and scientific and technical papers often use a translation memory or a bilingual dictionary created from past translations. Therefore, a use case is conceivable in which lexically constrained machine translation is performed using constraint words/phrases automatically extracted from a bilingual dictionary.

However, in a case where constraint words/phrases are extracted by an automatic method, it is conceivable that a noise word/phrase is included in the extracted constraint words/phrases. That is, the conventional technology has an issue that constraint words/phrases cannot be appropriately extracted. Note that such an issue is not limited to the field of machine translation, and is an issue that can occur in all fields in which sequence conversion is performed using constraint information.

The present invention has been made in view of the above points, and an object thereof is to provide a technology that enables appropriate extraction of constraint information when sequence conversion is performed using constraint information.

### Solution to Problem

According to the disclosed technology, an extraction apparatus including:
a division unit that divides each of first information in a dictionary that is a set of a pair of the first information and second information and a first sequence into unit information; and
a constraint information extraction unit that extracts the second information corresponding to the first information matching unit information of the first sequence from the dictionary as constraint information used for generating a second sequence on a basis of the first sequence, is provided.

### Advantageous Effects of Invention

According to the disclosed technology, there is provided a technology that enables appropriate extraction of constraint information when sequence conversion is performed using constraint information.

### BRIEF DESCRIPTION OF DRAWINGS

FIG. 1 is a diagram illustrating an example of lexically constrained machine translation.

FIG. 2 is a diagram illustrating a configuration example of a generation apparatus 100.

FIG. 3 is a flowchart for describing operation of the generation apparatus 100.

FIG. 4 is a diagram illustrating a configuration example of an extraction unit 120.

FIG. 5 is a diagram illustrating a configuration example of the extraction unit 120.

FIG. 6 is a diagram illustrating a configuration example of the generation apparatus 100.

FIG. 7 is a diagram illustrating a configuration example of a sequence generation unit 140.

FIG. 8 is a diagram illustrating a configuration example of a machine translation model.

FIG. 9 is a diagram illustrating a configuration example of the sequence generation unit 140.

FIG. 10 is a diagram illustrating a display image by a display unit 500.

FIG. 11 is a diagram illustrating a configuration example of the generation apparatus 100.

FIG. 12 is a diagram illustrating detailed settings and hyperparameters serving as a base in each setting used in an experiment.

FIG. 13 is a diagram illustrating an evaluation result.

FIG. 14 is a diagram illustrating a hardware configuration example of a device.

### DESCRIPTION OF EMBODIMENTS

Hereinafter, an embodiment of the present invention (“present embodiment”) will be described with reference to the drawings. The embodiment to be described below is merely exemplary, and embodiments to which the present invention is applicable are not limited to the following embodiment.

In the embodiment described below, an example in which the present invention is applied to machine translation is indicated, but the present invention can be applied to any field of sequence conversion in which sequence conversion is performed using constraint information. For example, the present invention can also be used for a summary task, a speech sentence generation task, a task of attaching an explanatory sentence to an image, and the like.

In the embodiment to be described below, the unit of translation is a sentence, but the unit of translation may be any unit.

A generation apparatus 100 to be described below provides specific improvement over the conventional technology in which constrained sequence conversion is performed, and indicates improvement in the technical field related to constrained sequence conversion. Furthermore, an extraction apparatus to be described below provides specific improvement over the conventional technology in extraction of constraint information, and indicates improvement in the technical field related to extraction of constrained information.

### Issues

Prior to describing a configuration and operation according to the present embodiment in detail, first, the conventional technology and an issue thereof will be described. The following description of the issue is not a publicly known technology. The issue described below is an issue related to the technology of the embodiment.

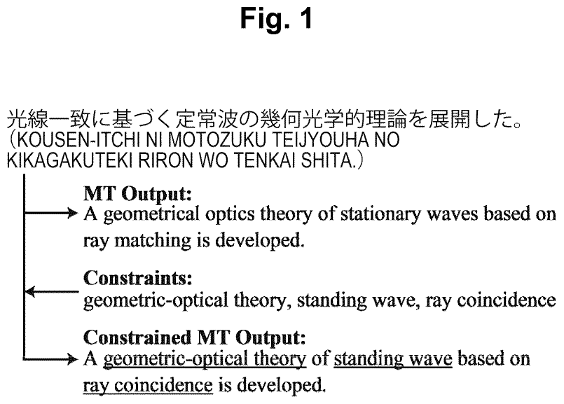

As described above, translation with a constraint for the purpose of including all specified words/phrases when a sentence in a certain domain is converted into another domain (for example, another language) is referred to as “lexically constrained machine translation”. For reference, FIG. 1 illustrates an example of input and output in lexically constrained machine translation.

In the example of FIG. 1, machine translation (MT output), constraint words/phrases (constraints), and lexically constrained machine translation (constrained MT output) are illustrated for a source language sentence “ [symbol] [symbol] [symbol] [symbol] (Kousen-itchi ni motozuku teijyouha no kikagakuteki riron wo tenkai shita.) [“A geometric-optical theory of standing wave based on ray coincidence is developed.”]”. Underlined parts indicate constraint words/phrases.

As the conventional technology of lexically constrained machine translation, Non Patent Literature 1 “Chen, G., Chen, Y., and Li, V. O. (2021). “Lexically constrained Neural Machine Translation with Explicit Alignment Guidance.” Proceedings of the AAAI Conference on Artificial Intelligence” discloses a lexically constrained machine translation method for manually created constraint words/phrases. The method disclosed in Non Patent Literature 1 is also referred to as a “soft method”. In the method disclosed in Non Patent Literature 1, there is no guarantee that constraint words/phrases are always included in a translation sentence.

Non Patent Literature 2 “Matt Post and David Vilar. 2018. Fast Lexically Constrained Decoding with Dynamic Beam Allocation for Neural Machine Translation. In Proceedings of the 2018 Conference of the North American Chapter of the Association for Computational Linguistics: Human Language Technologies, Volume 1 (Long Papers), pages 1314-1324, New Orleans, Louisiana. Association for Computational Linguistics” and Reference Literature 1 “Chousa, K. and Morishita, M. (2021). “Input Augmentation Improves Constrained Beam Search for Neural Machine Translation: NTT at WAT 2021.” In Proceedings of the 8th Workshop on Asian Translation (WAT), pp. 53-61, Online. Association for Computational Linguistics.” also disclose a lexically constrained machine translation method for manually created constraint words/phrases. In this method, there is a guarantee that constraint words/phrases are always included in a translation sentence. This method is also referred to as a “hard method”.

There is also a use case where constraint words/phrases are automatically created instead of being manually created. For example, a translation memory or a bilingual dictionary created from past translations is often used for translation of a document in a domain including many proper nouns such as a patent or a scientific and technical paper, and thus a use case is considered in which lexically constrained machine translation is performed using constraint words/phrases automatically extracted from a bilingual dictionary.

On the other hand, in a case where constraint words/phrases are automatically extracted, it is conceivable that a noise word/phrase is included in the extracted constraint words/phrases. Furthermore, even in a case where constraint words/phrases are extracted manually, noise can be included.

In the conventional lexically constrained machine translation methods disclosed in Non Patent Literature 1 and 2 and the like, it is assumed that given constraint words/phrases are included in a reference translation. Therefore, in a case where a lexically constrained machine translation method is applied using extracted constraint words/phrases as lexical constraints, an incorrect word/phrase may be included in a translation sentence, and it is assumed that the translation accuracy is degraded.

In view of the above, the following describes a technology for reducing noise and appropriately extracting constraint words/phrases, and a technology for accurately performing lexically constrained machine translation even in a case where a set of constraint words/phrases that may include noise is used.

### Device Configuration Example and Overall Operation

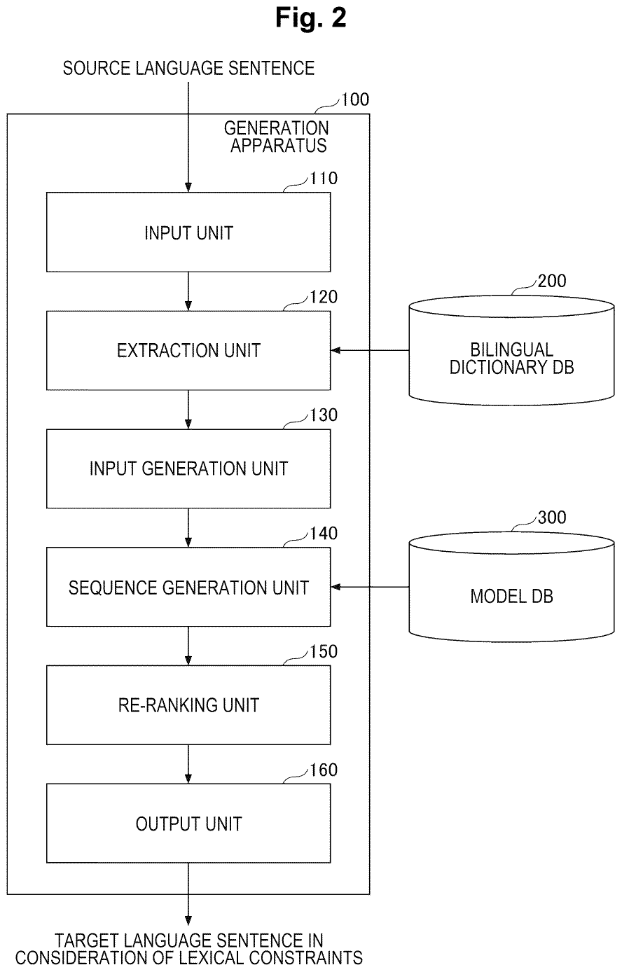

FIG. 2 illustrates a configuration example of the generation apparatus 100 according to the present embodiment. As illustrated in FIG. 2, the generation apparatus 100 includes an input unit 110, an extraction unit 120, an input generation unit 130, a sequence generation unit 140, a re-ranking unit 150, and an output unit 160.

Further, a bilingual dictionary DB 200 and a model DB 300 are included. The bilingual dictionary DB 200 stores a bilingual dictionary, and the model DB 300 stores a trained machine translation model. The bilingual dictionary DB 200 and the model DB 300 may be included outside the generation apparatus 100 (example of FIG. 2) or may be included inside the generation apparatus 100.

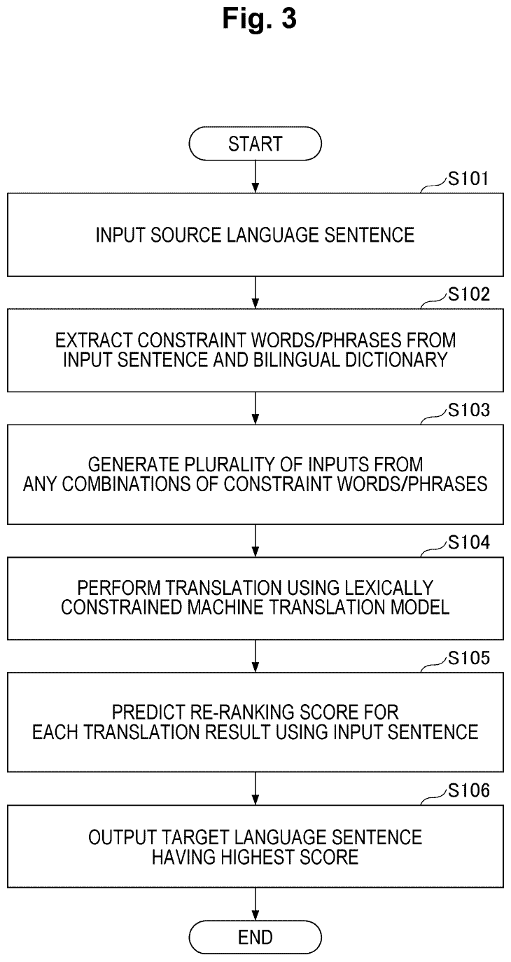

The flow of the entire operation by the generation apparatus 100 will be described with reference to the flowchart of FIG. 3. In step S101, a source language sentence is input by the input unit 110. In step S102, the extraction unit 120 automatically extracts constraint words/phrases based on the source language sentence (input sentence) input by the input unit 110 and the bilingual dictionary read from the bilingual dictionary DB 200.

In S103, the input generation unit 130 generates a plurality of inputs (lexical constraints) from any combinations of constraint words/phrases. In S104, the sequence generation unit 140 translates the input sentence using the plurality of inputs generated in S103 and the machine translation model read from the model DB 300. Here, a translation result is obtained for each of the plurality of inputs generated in S103. That is, the sequence generation unit 140, using a certain sequence and lexical constraints, generates one or a plurality of candidates for another sequence based on a sequence conversion model learned in advance.

In S105, the re-ranking unit 150 predicts a re-ranking score for each translation result using the input sentence. In step S106, the output unit 160 outputs the translation result (target language sentence) having the highest score. Hereinafter, configurations and operations of main functional units will be described in detail.

### Extraction Unit 120

First, the extraction unit 120 will be described.

The extraction unit 120 receives a source language sentence and a bilingual dictionary as inputs, and outputs the source language sentence and a constraint word/phrase list. Note that the source language sentence may not be output.

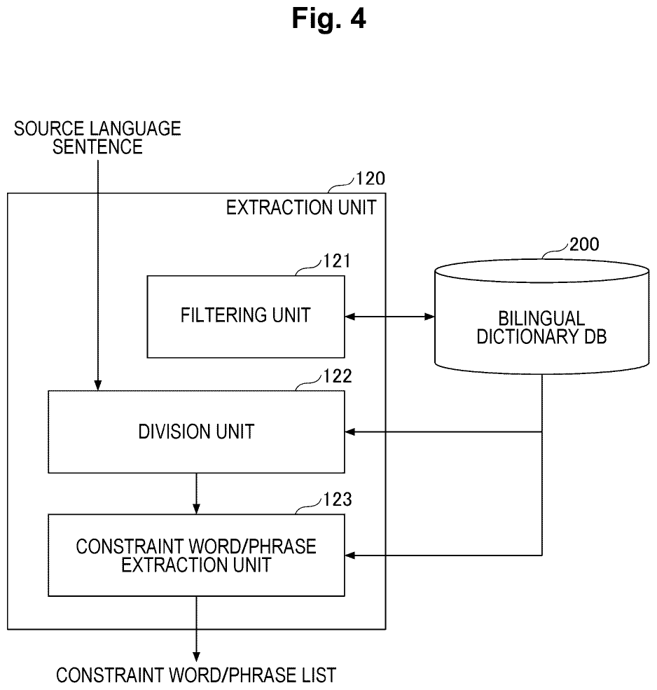

FIG. 4 is a configuration diagram of the extraction unit 120. As illustrated in FIG. 4, the extraction unit 120 includes a filtering unit 121, a division unit 122, and a constraint word/phrase extraction unit 123. Further, the extraction unit 120 refers to the bilingual dictionary 200. Note that the extraction unit 120 may not include the filtering unit 121.

The bilingual dictionary DB 200 stores a set of pairs of two words/phrases to be associated with each other when a sequence is converted. Specifically, in the present embodiment for translation, the bilingual dictionary DB 200 stores a set of <source language word/phrase, target language word/phrase> pairs. Each of the source language word/phrase and the target language word/phrase may be composed of a plurality of words. In the present embodiment, one <source language word/phrase, target language word/phrase> pair is referred to as a “bilingual translation”. The source language word/phrase and the target language word/phrase may be referred to as a “source language translation word” and a “target language translation word”, respectively.

Note that, when the bilingual dictionary DB 200 is used for a task other than translation, the content thereof is not limited to a set of <source language word/phrase, target language word/phrase> pairs.

The filtering unit 121 filters out a bilingual translation that is noise, from the bilingual dictionary. The bilingual dictionary after filtering is stored in the bilingual dictionary DB 200, and the division unit 122 and the constraint word/phrase extraction unit 123 refer to the bilingual dictionary after filtering.

The division unit 122 morphologically analyzes a source language sentence and source language words/phrases in the bilingual dictionary. That is, the division unit 122 divides a source language sentence and source language words/phrases in the bilingual dictionary into unit information. The constraint word/phrase extraction unit 123 extracts bilingual translations corresponding to words/phrases (example of unit information obtained by division) included in the source language sentence and creates a constraint word/phrase list. Hereinafter, the process in each unit will be described in more detail.

### Extraction Unit 120: Filtering Unit 121

The filtering unit 121 deletes bilingual translations, or words/phrases included in bilingual translations, from the bilingual dictionary, if the following rules (A) to (C) apply. However, it is not essential that all of the rules (A) to (C) apply; the filtering unit 121 may delete bilingual translations or words/phrases if at least one of the rules (A) to (C) applies. Furthermore, bilingual translations, or words/phrases included in bilingual translations, may be filtered based on rules other than the rules (A) to (C). In particular, those to which the rule (C) applies may be retained in the Modifications 1 and 2, which will be described later.
(A) A bilingual translation including a word/phrase other than a noun/noun phrase (except a verb due to conjugation)
(B) A bilingual translation composed of a word/phrase having a length of 1

A bilingual translation including one character such as a unit is an example of (B). For example, a bilingual translation of “target language: C, source language: [symbol] (do) [“degree”]” corresponds to (B).
(C) A bilingual translation having no uniqueness in a correspondence between a source language and a target language (for example, a bilingual translation having a plurality of translation words for one word/phrase on the source language side).

A bilingual translation to which the rule (C) applies is deleted. Alternatively, one translation word is left and the rest of the translation words among a plurality of potential translation words are deleted, so that the source language word/phrase and the target language word/phrase are associated with each other on a one-to-one basis. Any method may be used as a method of leaving one translation word and deleting the rest of the translation words among a plurality of potential translation words. For example, a method of leaving the translation word that is written first, a method of leaving the translation word that appears most frequently, or the like can be used.

For example, a bilingual translation of “source language: computer, target language: [symbol] (keisanki) [“calculator”], [symbol] (konpyuuta) [“computer”]” corresponds to (C), and in this case, for example, the bilingual translation is deleted, or the source language word/phrase and the target language word/phrase are set to be on a one-to-one basis as in “target language: computer, source language: [symbol] (keisanki) [“calculator”]”.

### Extraction Unit 120: Division Unit 122

The division unit 122 divides (tokenizes) a source language sentence and source language translation words in the bilingual dictionary into morpheme units, and inserts predetermined symbols (examples: blank, “/”, etc.) at morpheme boundaries. The division unit may be different from the division unit in division processing performed when translation is performed thereafter.

For example, when the source language sentence is “ [symbol] (sono kagiri de ha nai) [“not limited thereto”]”, the source language sentence after the processing by the division unit 122 is “ [symbol] (sono/kagiri/de/ha/nai) [“not limited thereto”]”).

### Extraction Unit 120: Constraint Word/Phrase Extraction Unit 123

The constraint word/phrase extraction unit 123 extracts bilingual translations corresponding to words/phrases included in a source language sentence and creates a constraint word/phrase list using the extracted bilingual translations. An example of a specific constraint word/phrase extraction method will be described below. Note that a dictionary form, a search method, and the like are not limited to a method to be described below and may be another method as long as the method can extract constraint words/phrases corresponding to words/phrases included in a source language sentence.

In this example, as the bilingual dictionary, an expression using a data structure referred to as “Trie tree” in units of characters of a source language translation word is used.

The constraint word/phrase extraction unit 123 advances a prefix search from the beginning of a source language sentence, targeting a set of source language translation words in the bilingual dictionary. When a bilingual translation (pair) including a source language translation word matching a word/phrase included in the source language sentence is found, the target translation word is extracted as a constraint word/phrase. In the prefix search, a bilingual translation having the longest word/phrase length of the source language translation word is selected.

For example, it is assumed that three words/phrases, that is, “ABC/GHI/XYZ” are obtained as a result of division in the morphological analysis by the division unit 122 in the source language sentence. Here, A, B, C, and the like are characters. When the constraint word/phrase extraction unit 123 performs a search on source language translation words in the bilingual dictionary using “ABC/GHI/XYZ”, matches are found from the beginning (or front) of the sentence “ABC/GHI/XYZ”.

As a result of the above search, for example, even when there are four matches of words/phrases of “AB”, “ABC”, “ABCG”, and “ABC/GHI”, “AB” and “ABCG” can be made unmatched as described below because the units of morphemes are not matched. In this case, out of the remaining “ABC” and “ABC/GHI”, a target translation word paired with “ABC/GHI” having the longest word/phrase length of the source language translation word is extracted as a constraint word/phrase. Thereafter, similar processing is executed using “XYZ,” which is the portion after “ABC/GHI”.

As in the present embodiment, the division unit 122 divides a source language sentence and source language translation words in the bilingual dictionary into morphemes (example of unit information) in advance, and performs a search in consideration of morpheme boundaries, whereby erroneous extraction of a word/phrase having an unmatched division unit can be prevented. This is particularly effective in a case where the source language is a language such as Japanese in which word separation is not performed. For example, a source language translation word “ [symbol] (hana) [“flower”]” can be prevented from being matched with a source language sentence “ [symbol] (sono/kagiri/de/ha/nai) [“not limited thereto”]”. That is, “hana” cannot be matched with “ha/na”.

Note that execution of prefix search, longest match search, and word division as described here is an example of means for implementing constraint word/phrase extraction with less noise and reduced ambiguities. Another means capable of resolving ambiguities may be used.

For example, when the division unit 122 performs morphological analysis, information necessary for resolving ambiguities such as a part of speech, an original form, a word stem, a conjugation form, and reading (pronunciation) is added to divided words/phrases, and matching is performed using the added information. That is, using not only a character string but also attached information such as the part of speech at the time of matching can resolve ambiguities when, for example, a character “in” in a source language sentence matches both the preposition “in” and the noun “inn” (lodge) that are source language translation words. At the time of matching, resolving ambiguities is an important factor for improving the accuracy of translation.

### Another Example of Configuration of Extraction Unit 120

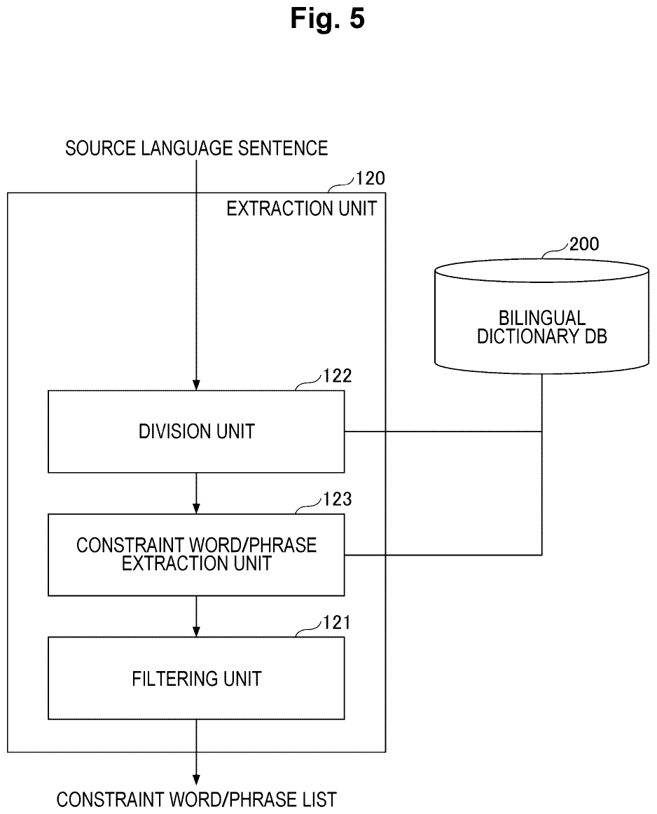

Note that the extraction unit 120 may have a configuration illustrated in FIG. 5 instead of the configuration illustrated in FIG. 4. In the configuration illustrated in FIG. 5, instead of filtering the bilingual dictionary, the filtering unit 121 performs filtering on constraint words/phrases extracted by the constraint word/phrase extraction unit 123.

The filtering process is similar to the process by the filtering unit 121 described above. However, “bilingual translation” is replaced with “constraint word/phrase”. Specifically, the filtering unit 121 deletes constraint words/phrases that correspond to the following (A) to (C), from an extraction result by the constraint word/phrase extraction unit 123. However, it is not essential for the filtering unit 121 to delete all of (A) to (C), and at least one of (A) to (C) may be deleted. Rules other than (A) to (C) may be used. In particular, (C) below may be retained when the Modifications 1 and 2 to be described below apply.
(A) A constraint word/phrase other than a noun/noun phrase (verb is deleted due to conjugation).
(B) A constraint word/phrase having a length of 1.
(C) A constraint word/phrase having no uniqueness in a correspondence between a source language and a target language (for example, constraint word/phrase having a plurality of constraint words/phrases for one word/phrase on the source language side).

When (C) is deleted and there is a plurality of constraint words/phrases for one word/phrase in the source language part, for example, the plurality of constraint words/phrases is deleted, or one constraint word/phrase is left and the rest of the plurality of constraint words/phrases is deleted, so that the source language word/phrase and the target language word/phrase are associated with each other on a one-to-one basis.

### Another Configuration Example of Extraction Unit 120 and Generation Apparatus 100

The extraction unit 120 may be a single device independent of the generation apparatus 100. This single device may be referred to as an “extraction apparatus”. Note that, for the extraction unit 120 included in the generation apparatus 100, the extraction unit 120 may also be referred to as an “extraction apparatus”. The generation apparatus 100 including the extraction unit 120 may be referred to as an “extraction apparatus”. Both the extraction unit 120 and the extraction apparatus may include both or any one of a display information generation unit 170 and a modification unit 180 in an example to be described below.

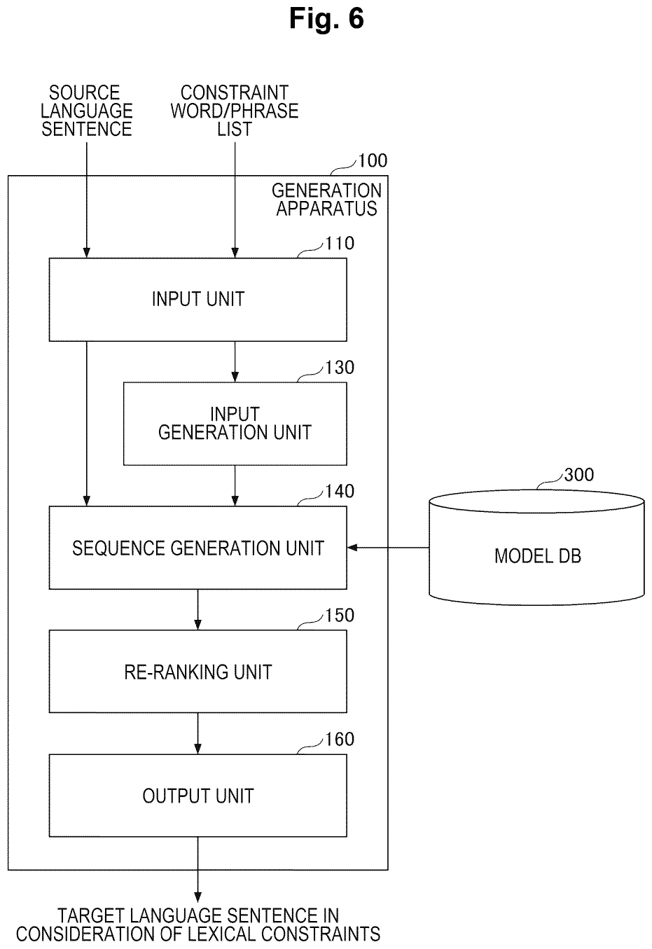

When the extraction unit 120 is formed as a single device independent of the generation apparatus 100, the generation apparatus 100 may not include the extraction unit 120. FIG. 6 illustrates a configuration of the generation apparatus 100 in this case. In the configuration of FIG. 6, a constraint word/phrase list generated by the extraction apparatus is input to the generation apparatus 100. However, in the configuration of FIG. 6, a constraint word/phrase list that is not a constraint word/phrase list generated by the extraction apparatus (example: constraint word/phrase list including a lot of noise) may be input to the generation apparatus 100.

The operation of the input generation unit 130, the sequence generation unit 140, and the re-ranking unit 150 in FIG. 6 are the same as the operation of the input generation unit 130, the sequence generation unit 140, and the re-ranking unit 150 in FIG. 2.

### Input Generation Unit 130

Next, the input generation unit 130 will be described. The input generation unit 130 receives a constraint word/phrase list as an input, and sets all elements of subsets for words/phrases included in the constraint word/phrase list as lexical constraints. However, some of all the elements may be used as lexical constraints.

Finally, the input generation unit 130 outputs the above-described lexical constraints as lexical constraints corresponding to a source language sentence input to the extraction unit 120. A specific example will be described below.

It is assumed that {A, B, C} is input to the input generation unit 130 as the constraint word/phrase list. Here, each of A, B, and C is a constraint word/phrase.

The input generation unit 130 extracts { }, {A}, {B}, {C}, {A, B}, {A, C}, {B, C}, and {A, B, C} as subset elements of {A, B, C}, and outputs each subset element as a lexical constraint.

Note that {{ }, {A}, {B}, {C}, {A, B}, {A, C}, {B, C}, {A, B, C}} are a lexical constraint set, and one { . . . } is one lexical constraint.

The number of lexical constraints created from subsets of a list C of constraint words/phrases is 2^{|C|}, and as will be described below, a plurality of translation sentence candidates is obtained from each of the lexical constraints.

### Sequence Generation Unit 140

Next, the sequence generation unit 140 will be described. It is assumed that the sequence generation unit 140 holds a trained machine translation model read from the model DB 300. The sequence generation unit 140 repeats the following process by the number of lexical constraints (the number of elements of a set of lexical constraints). For example, assuming that the set of lexical constraints is {{ }, {A}, {B}, {C}, {A, B}, {A, C}, {B, C}, {A, B, C}}, the process is repeated eight times.

The sequence generation unit 140 receives an input sentence (source language sentence) and lexical constraints as inputs. The sequence generation unit 140 generates a translation sentence (target language sentence) using the machine translation model by applying an existing method of lexically constrained machine translation. Here, a plurality of translation sentences is generated as translation sentence candidates (target language sentence candidates). Further, the translation sentence candidates are given scores as translation sentences.

As an existing method of lexically constrained machine translation, any method may be used. For example, LeCA or LeCA+LCD can be used. LeCA is disclosed in Non Patent Literature 1, and is also referred to as a “soft method”. LeCA +LCD is disclosed in the above-described Reference Literature 1, and is also referred to as a “hard method”.

The sequence generation unit 140 outputs the plurality of generated translation sentence candidates. As an example, the sequence generation unit 140 outputs a predetermined number of translation sentence candidates in descending order of scores. The “predetermined number” may be one. That is, only the translation sentence having the highest score may be output. Here, for example, 30 translation sentence candidates are output per one lexical constraint.

### Configuration Example of Sequence Generation Unit 140

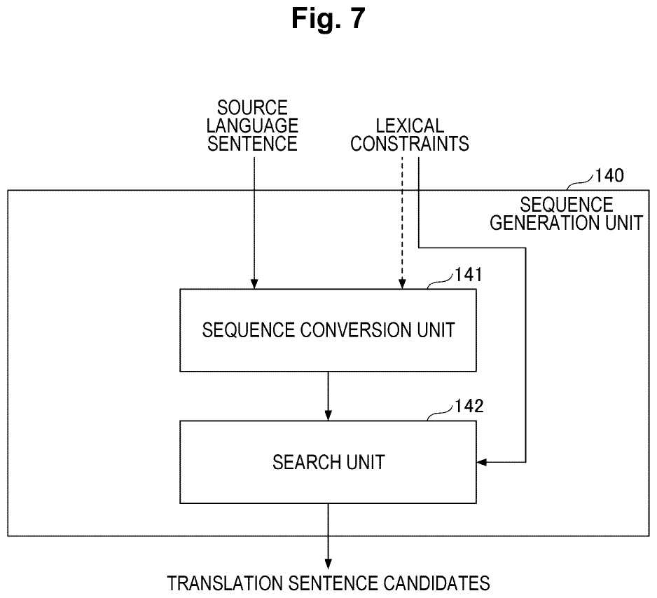

FIG. 7 illustrates a configuration example of the sequence generation unit 140. As illustrated in FIG. 7, the sequence generation unit 140 includes a sequence conversion unit 141 and a search unit 142.

Note that, when the soft method is used for generating a translation sentence, the sequence conversion unit 141 uses information of lexical constraints, and, when the hard method is used, the sequence conversion unit 141 may or may not use lexical constraints, depending on the type of the hard method. An arrow of input to the sequence conversion unit 141 regarding lexical constraints is illustrated by a dotted line. In the above-described LeCA+LCD of hard methods, the sequence conversion unit 141 uses information of lexical constraints. Hereinafter, a configuration/operation assuming LeCA+LCD will be described.

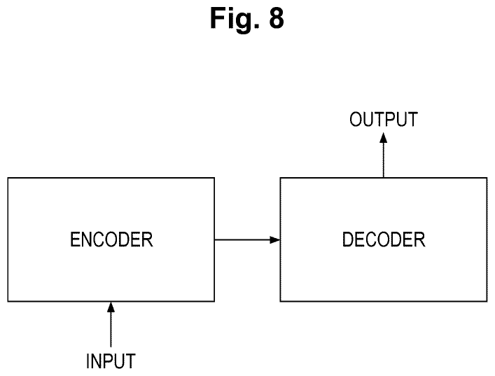

In the sequence conversion unit 141, as illustrated in FIG. 8, a model based on a general encoder-decoder model (for example, Transformer) including an encoder and a decoder can be used as a machine translation model. However, the present invention can be implemented using a model other than the encoder-decoder model.

The sequence conversion unit 141 receives a source language sentence and lexical constraints as inputs, and extends the source language sentence using the lexical constraints, thereby creating an input sequence to which information of the lexical constraints is added and using the input sequence as an input to the machine translation model.

More specifically, in the above extension, the sequence conversion unit 141 couples (connects) a source language sentence X, which is the input sequence, and each of the constraint words/phrases Cᵢ via a character string indicating a special delimiter <sep> as described below, thereby creating a lexically constrained input sequence. <eos> is a character string indicating the end of the sentence.
[X, <sep>, C₁, <sep>, C₂, . . . , C_{N}, <eos>]

The sequence conversion unit 141 generates a sentence using the extended input sequence as an input to the machine translation model. More specifically, the probability of each word in a set of words that can form an output sequence is output.

The search unit 142 searches for (an approximate solution of) an output sequence having the maximum generation probability when an input sequence is given, using the output probability of the decoder in the machine translation model. The search unit 142 enables ensuring that the output sequence satisfies all constraint lexicons by using a grid beam search method based on a beam search.

The search unit 142 performing a search using a grid beam search is an example. Any processing method may be used as long as it is the processing method in which a lexically constrained search is performed so as to include constraint words/phrases.

### Re-Ranking Unit 150

Next, the re-ranking unit 150 will be described. The re-ranking unit 150 receives, as an input, one or more translation sentence candidates generated by the sequence generation unit 140. For example, assuming that the sequence generation unit 140 generates 30 translation sentence candidates per one lexical constraint and that there are eight lexical constraints, the re-ranking unit 150 receives as inputs 30 translation sentence candidates per one lexical constraint in the eight lexical constraints.

Next, the re-ranking unit 150 calculates a score for each of the translation sentence candidates using an input sentence (source language sentence), and outputs a translation sentence candidate having the best score as a final translation sentence. Here, all (or some) of the translation sentences and the scores may be output without narrowing the translation sentences to the translation sentence having the highest score. As a result, the output unit 160 can present the translation sentences to the user in a ranking form using the scores.

As a method of calculating a score by the re-ranking unit 150, any method can be used as long as a score of a translation sentence can be calculated, and for example, methods of the following Examples 1 and 2 can be used.

### Example 1

The re-ranking unit 150 uses a likelihood of a translation sentence candidate output from the machine translation model used for translation by the sequence generation unit 140 as a score.

### Example 2

The re-ranking unit 150 uses, as a re-ranking model, a machine translation model obtained by learning a right-to-left translation task for generating a translation sentence from the end of the sentence to the beginning of the sentence using a transformer that is an encoder-decoder model, and uses, as a score, a likelihood obtained when a translation sentence candidate is forcibly output using the re-ranking model. The forcible output of a translation sentence candidate may be rephrased as forced decoding using a translation sentence candidate.

That is, a source language sentence is input to the encoder of the re-ranking model, and words of a translation sentence candidate having a score (likelihood) that is desired to be evaluated are sequentially input to the decoder of the re-ranking model.

Note that, in Examples 1 and 2, the likelihood output by the machine translation model may be any value as long as the value indicates appropriateness. The likelihood output by the machine translation model may be a probability or a value other than the probability.

Furthermore, the re-ranking unit 150 may calculate a re-ranking score using both the likelihood of Example 1 and the likelihood of Example 2. For example, the average of the likelihood of Example 1 and the likelihood of Example 2 may be used as a re-ranking score.

### Modification 1

Next, Modification 1 will be described. In Modification 1, a constraint word/phrase list, in which a plurality of target language words/phrases corresponds to one word/phrase of a source language, can be used as a constraint word/phrase list generated by the extraction unit 120. Such a constraint word/phrase list may be referred to as a “constraint word/phrase list” that allows a plurality of translation words. For example, when the filtering unit of the extraction unit 120 does not perform the procedure of (C), such a constraint word/phrase list may be generated.

For example, it is assumed that there are A and A′ as a plurality of target language words/phrases for a certain word/phrase of a source language, and “A, A′, B, C,” including A and A′, B, and C, is generated as a plurality of elements of a constraint word/phrase list by the extraction unit 120. For example, when a word/phrase of the source language sentence is “computer” and words/phrases of the target language sentence are “calculator” and “computer”, A and A′ correspond to “calculator” and “computer”.

Here, such a constraint word/phrase list including a plurality of elements is expressed as {{A, A′}, {B}, {C}}.

The input generation unit 130, to which {{A, A′}, {B}, {C}} is input from the extraction unit 120, generates {A′}, {A′, B}, {A′, C}, and {A′, B, C} as lexical constraints, in addition to { }, {A}, {B}, {C}, {A, B}, {A, C}, {B, C}, and {A, B, C}.

The input generation unit 130 inputs each of a plurality of generated lexical constraints to the sequence generation unit 140.

The sequence generation unit 140 performs lexically constrained machine translation 12 times and obtains translation sentence candidates by using each of the 12 lexical constraints of { }, {A}, {B}, {C}, {A, B}, {A, C}, {B, C}, {A, B, C}, {A′}, {A′, B}, {A′, C}, and {A′, B, C} as a lexical constraint. For example, if one translation sentence candidate is generated for one lexical constraint, 12 translation sentence candidates are obtained.

After performing the lexically constrained machine translation, the re-ranking unit 150 performs the re-ranking process according to the methods described above, and outputs, for example, a translation sentence candidate having the highest score as a final translation sentence.

### Modification 2

Next, Modification 2 will be described. Also in Modification 2, a constraint word/phrase list, in which a plurality of target language words/phrases corresponds to one word/phrase of a source language, can be used as a constraint word/phrase list generated by the extraction unit 120.

In Modification 2, in the process of searching for a translation sentence by the search unit 142 of the sequence generation unit 140, a search may be performed such that a plurality of phenotypes are allowed for one constraint word/phrase. That is, the search may be performed such that one element from a candidate of each constraint word/phrase is satisfied. Details are as follows.

Also in Modification 2, it is assumed that there are A and A′ as a plurality of target language words/phrases for a certain word/phrase of a source language, and “A, A′, B, C” including A, A′, B, and C is generated as a plurality of elements of a constraint word/phrase list by the extraction unit 120. Here, it is assumed that {A, B, C} is generated as the constraint word/phrase list, and information indicating that A may be A′ is input from the extraction unit 120 to the input generation unit 130. Alternatively, it may be assumed that {A, A′, B, C} is generated as the constraint word/phrase list, and information indicating that either A or A′ is used is input from the extraction unit 120 to the input generation unit 130. Note that, in the above description, an example of a form in which two ambiguities are allowed for one constraint word/phrase is indicated, but a form in which three or more ambiguities are allowed for one constraint word/phrase may be used.

For example, when three ambiguities are allowed for A, it is assumed that {A, B, C} is generated as the constraint word/phrase list, and information indicating that A may be A′ or A″ is input from the extraction unit 120 to the input generation unit 130. Alternatively, it may be assumed that {A, A′, A″, B, C} is generated as the constraint word/phrase list, and information indicating that any one of A, A′, or A″ is used is input from the extraction unit 120 to the input generation unit 130.

When A may be A′, the input generation unit 130 generates seven lexical candidate constraints of { }, {{A, A′}}, {{B}}, {{C}}, {{A, A′}, {B}}, {{A, A′}, {C}}, and {{A, A′}, {B}, {C}} for the constraint word/phrase list {A, B, C}. Note that, in Modification 2, since there is a case where a plurality of target language words/phrases (example: A, A′) corresponds to a certain source language word/phrase, there are ambiguities in a translation word, and a lexicon to be used as a constraint is not confirmed, and thus, they are referred to as “lexical candidate constraints”, instead of “lexical constraints”. That is, a “lexical candidate constraint” is a lexical constraint that retains ambiguities. The above expression of a lexical candidate constraint is an example. An expression other than the above expression may be used as the expression as long as it can express that either A or A′ is used.

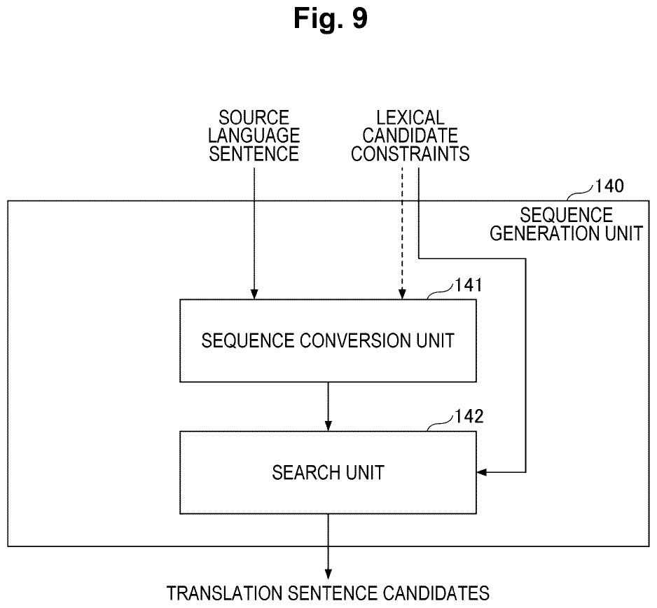

As illustrated in FIG. 9, the sequence generation unit 140 receives, as inputs, lexical candidate constraints together with a source language sentence. The sequence generation unit 140 performs lexically constrained machine translation seven times and obtains translation sentence candidates using each of the seven lexical candidate constraints of { }, {{A, A′}}, {{B}}, {{C}}, {{A, A′}, {B}}, {{A, A′}, {C}}, {{A, A′}, {B}, {C}} as lexical candidate constraints. For example, if one translation sentence candidate is generated for one lexical candidate constraint, seven translation sentence candidates are obtained.

After the lexically constrained machine translation is performed, the re-ranking unit 150 performs the re-ranking process according to the methods described above, and outputs, for example, a translation sentence candidate having the highest score as a final translation sentence.

When a lexical candidate constraint including {A, A′} is used, the search unit 142 of the sequence generation unit 140 executes a search on the assumption that a word A may be A′. That is, a search taking into account the ambiguities is executed. For the search, for example, the method of Reference Literature 2 “Peter Anderson, Basura Fernando, Mark Johnson, and Stephen Gould. 2017. Guided Open Vocabulary Image Captioning with Constrained Beam Search. In Proceedings of the 2017 Conference on Empirical Methods in Natural Language Processing, pages 936-945, Copenhagen, Denmark. Association for Computational Linguistics” disclosed in https://aclanthology.org/D17-1098/ can be used. This method is an example of a method of “a search taking into account the ambiguities”.

In the method disclosed in Reference Literature 2, a lexically constrained beam search is performed taking into account the ambiguities of a translation word that may be either A or A′. That is, ambiguities of A and A′ are resolved at the time of a beam search.

Note that the method disclosed in Reference Literature 2 is a language generation method, but is not a translation technology. There is no conventional technology in which this method is applied to a search at the time of decoding translation.

Note that, in the description of the embodiment and the description of Modifications 1 and 2 so far, a plurality of target language words/phrases (example: A, A′) for a word/phrase of a certain source language do not have to be synonyms such as, for example, “calculator” and “computer”, but may also be non-synonymous words/phrases such as, for example, “trunk” of a car, “trunk” of an elephant, a tree's “trunk”, and a “trunk” line, for “trunk”. Since the meaning of a word is not taken into account at the time of a search in the search unit 142, A and A′ may be completely unrelated words/phrases.

Furthermore, when the technology according to the present invention is used in a task other than translation, what corresponds to a plurality of words in a sequence after conversion for words of the original sequence may be set using any criterion.

Furthermore, in the description of the embodiment and the description of Modifications 1 and 2, a word/phrase that is not the original form may be converted into the original form at the time of morphological analysis in consideration of word variation (plurality, change in tense, and the like).

For example, it is assumed that there is an English-Japanese bilingual dictionary and there is an entry of “corn-corn the plant, clavus””. In this case, it is assumed that a source language sentence “We roasted corns over the charcoal.” is input to the generation apparatus 100. In this case, when matching is performed in units of morphemes in the extraction unit 120, “corns” includes “corn” as a morpheme, and thus finds a match in the bilingual dictionary. However, for example, when the entry of the bilingual dictionary is “feet” and the morpheme in the input sentence is “foot”, there is no match. Therefore, this issue can be solved by changing “foot” to the original form and then searching for a match.

### Example

Next, as a more specific example, an example using the technology described above will be described. In the present example, in a display unit 500 (device capable of display and input operation) to be described below, a constraint word/phrase can be edited (modified, added) and a target language sentence (translation sentence) for the constraint word/phrase can be checked each time.

### Display Image

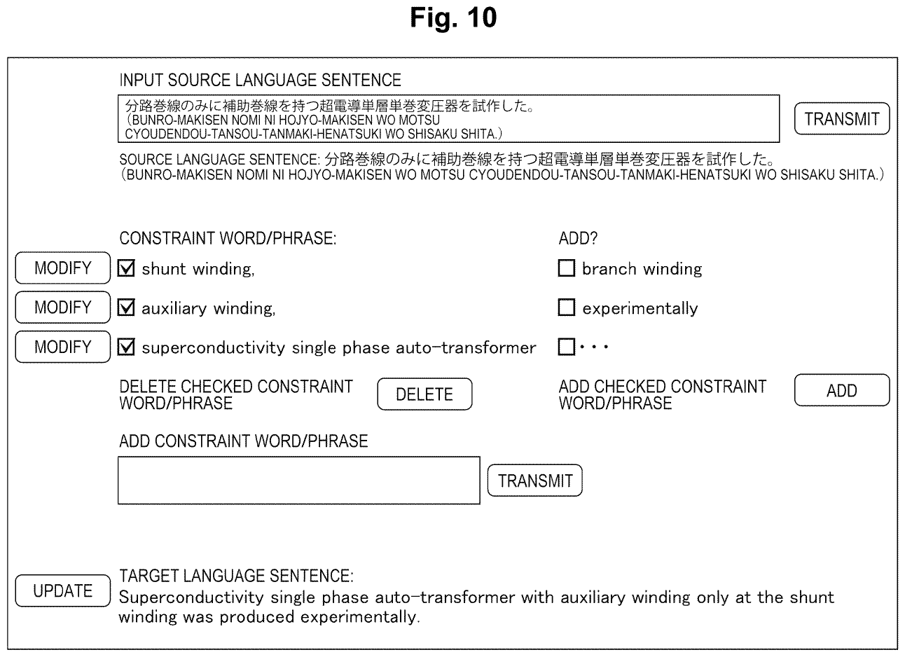

First, a display image on the display unit 500 will be described with reference to FIG. 10. In the example illustrated in FIG. 10, the user inputs “ [symbol] [symbol] [symbol] ” as a source language sentence, and presses “transmit”.

The display unit 500 displays a plurality of constraint words/phrases (constraint word/phrase list) for the input source language sentence. Here, the words/phrases displayed as the constraint words/phrases are words/phrases after filtering by the filtering unit 121.

To their right, the filtered constraint words/phrases are displayed in the form of “add?”.

The user can select a constraint word/phrase to be modified (or deleted) or added by marking a check box, and can modify (or delete)/add the selected constraint word/phrase by pressing a corresponding button.

Furthermore, a constraint word/phrase created by the user himself/herself can also be added.

By pressing “update” on the display image, a target language sentence using the constraint words/phrases at that time can be displayed.

### Device Configuration and Operation

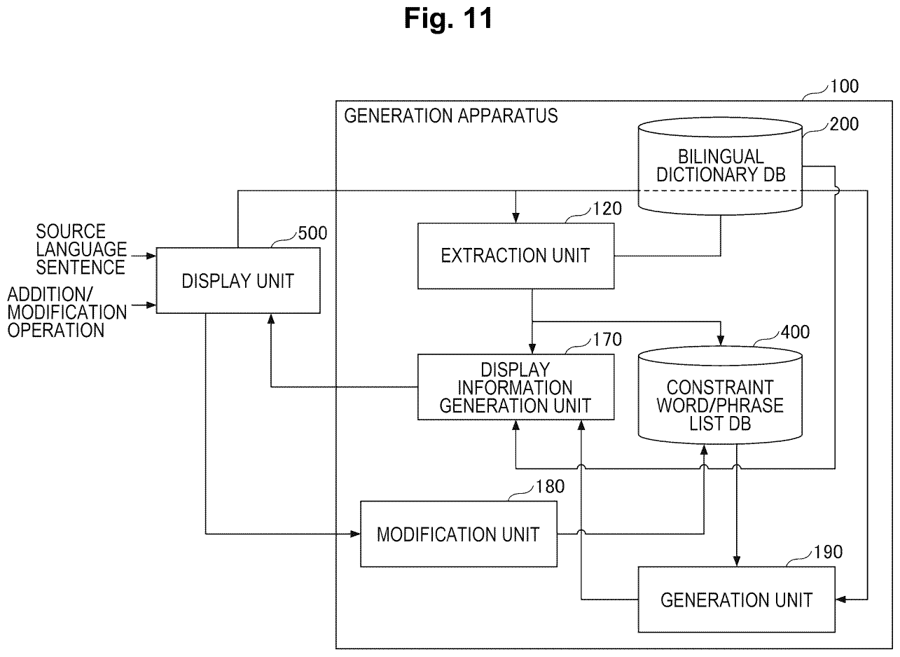

A configuration example of the generation apparatus 100 for implementing the display as described above is illustrated in FIG. 11. As illustrated in FIG. 11, the generation apparatus 100 of the present example includes the extraction unit 120, the display information generation unit 170, the modification unit 180, a generation unit 190, the bilingual dictionary DB 200, and a constraint word/phrase list DB 400. Note that the modification unit 180 may be included in the display information generation unit 170.

Note that the bilingual dictionary DB 200 and the constraint word/phrase list DB 400 may be included outside the generation apparatus 100. The generation unit 190 may also be included outside the generation apparatus 100 (for example, another server). The generation apparatus 100 may be used for the purpose of displaying a list of constraint words/phrases on the display unit 500. In that case, the generation apparatus 100 may include only the extraction unit 120 and the display information generation unit 170 among the functional units illustrated in FIG. 11. The generation apparatus 100 may be referred to as an “extraction apparatus”. The function of each unit is as follows.

The extraction unit 120 is the extraction unit 120 illustrated in FIG. 4 or 5. A constraint word/phrase list is output using a source language sentence as an input. The output constraint word/phrase list is stored in the constraint word/phrase list DB 400 and is input to the display information generation unit 170. Furthermore, the extraction unit 120 may output filtered constraint words/phrases as a filtered word/phrase list. The output filtered word/phrase list is input to the display information generation unit 170.

The display information generation unit 170 generates information for displaying a constraint word/phrase list (the information is referred to as “constraint word/phrase list presentation information”) on the display unit 500. The constraint word/phrase list presentation information includes a constraint word/phrase list. Furthermore, the constraint word/phrase list presentation information may include information of a filtered word/phrase list as deleted information, filtered candidate words/phrases, or addition candidates. The constraint word/phrase list presentation information is transmitted from the display information generation unit 170 to the display unit 500 and input to the display unit 500. The display information generation unit 170 may generate display information for displaying a constraint word/phrase together with a target language sentence (translation sentence) generated using the constraint word/phrase in a form in which modification can be made.

When the generation apparatus 100 receives an added or modified constraint word/phrase from the display unit 500, the display information generation unit 170 may acquire a target language sentence (translation sentence) generated based on the received constraint word/phrase, and generate display information for displaying the target language sentence (translation sentence).

The display information generation unit 170 may generate “modification support information” for allowing the user to check the constraint word/phrase list, and transmit the same to the display unit 500. The modification support information includes at least one of a source language sentence input by the user, an extracted constraint word/phrase list, or a target language sentence generated based on the extracted constraint word/phrase list.

The modification unit 180 receives at least one of an added constraint word/phrase or a modified constraint word/phrase from the display unit 500 as information obtained by modifying a presented constraint word/phrase list by the user.

The modification unit 180 modifies information stored in the constraint word/phrase list DB 400 based on the received information. In a case where a constraint word/phrase list is modified, a target language sentence may be generated again by lexically constrained machine translation based on the modified constraint word/phrase list, and the display information generation unit 170 may generate modification support information having the target language sentence and transmit the modification support information to the display unit 500, thereby displaying the modification support information on the display unit 500.

The generation unit 190 includes the input generation unit 130, the sequence generation unit 140, and the re-ranking unit 150. As described above, using these functional units, the generation unit 190 generates a target language sentence (translation sentence) in consideration of lexical constraints based on a constraint word/phrase list read from the constraint word/phrase list DB 400 and a source language sentence received from the display unit 500, and inputs the generated target language sentence to the display information generation unit 170.

The display unit 500 is, for example, a computer (terminal) including a display. The display unit 500 is connected to the generation apparatus 100 via a network.

As described with reference to FIG. 10, the display unit 500 receives a source language sentence from the user and displays a constraint word/phrase list and the like. The display unit 500 receives an addition/modification instruction for a constraint word/phrase or a source language sentence. The display unit 500 can output a source language sentence, a final target language sentence, and a final constraint word/phrase list as a set.

The generation apparatus 100 according to the above example interactively repeats modification of a constraint word/phrase list while checking a result of lexically constrained machine translation, so that a target language sentence (translation sentence) closer to a mental image of the user can be generated.

### Experimental Results

In the following description of experimental results, “generation apparatus 100 according to the present embodiment” is referred to as a “proposed method” or a “proposed system”.

In order to confirm effectiveness of a lexically constrained machine translation method based on re-ranking of translation candidates for lexical constraints automatically extracted by the proposed method, accuracy evaluation of lexically constrained machine translation based on lexical constraints automatically extracted from a bilingual dictionary, targeting Japanese to English translation was performed.

### Regarding Bilingual Dictionary

As a bilingual dictionary used for extracting lexical constraints, EDR Japanese to English bilingual dictionary (EDR-JE), which is a general-purpose dictionary, and a bilingual dictionary of the Japanese to English translation system ALT-J/E were used.

### Model

The following translation models were used for evaluation.
Transformer
LeCA+{EDR-JE, ALT-J/E}
LeCA+LCD+{EDR-JE, ALT-J/E}

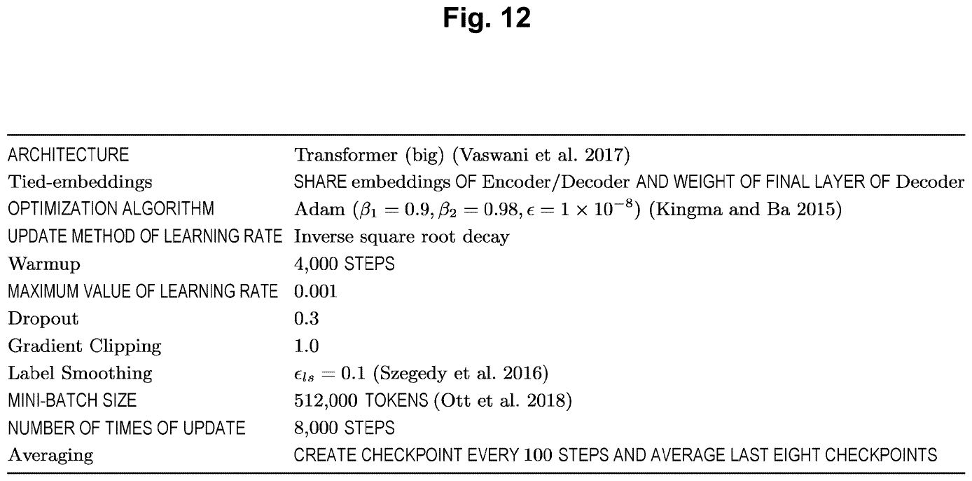

ASPEC was used as a bilingual translation corpus used for training and evaluation of the translation models. Detailed settings and hyperparameters of each of the models are illustrated in FIG. 12.

For constraints extracted from a dictionary, top 30 sentences of generated sentences were collected from each of 2^{|C|} lexical constraints. As a score used for re-ranking of translation candidates, a score calculated by a re-ranking model from a source language sentence and a translation candidate was used by the re-ranker.

As the re-ranking model, a model obtained by learning a right-to-left translation task for generating a translation sentence from the end of a sentence to the beginning of the sentence using a transformer (big) was used. The likelihood of forced decoding of an input translation candidate was used as the re-ranking score. BLEU, which is an automatic evaluation scale of translation accuracy, was used for evaluation of each method.

### Regarding Experimental Results

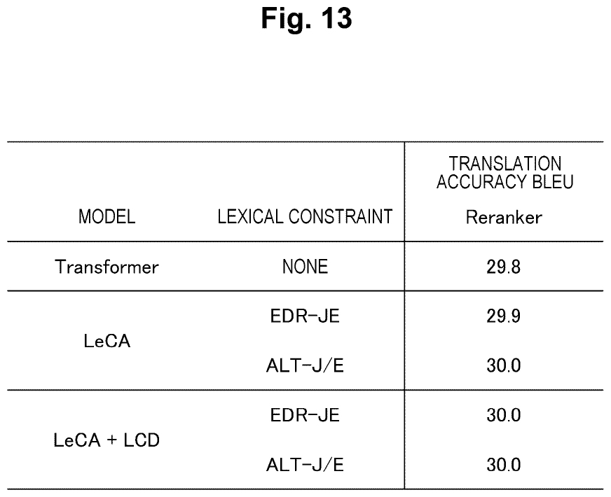

The translation accuracy of each method when using lexical constraints automatically extracted by the bilingual dictionary is indicated in FIG. 13. It can be seen that, in the re-ranker using a score based on the re-ranking model, LeCA and LeCA+LCD can improve the translation accuracy as compared with the baseline (Transformer). It can be also seen from FIG. 13 that the translation accuracy is high regardless of the type of dictionary.

### Hardware Configuration Example

Any device (generation apparatus 100, extraction apparatus) described in the present embodiment can be implemented by causing a computer to execute a program, for example. This computer may be a physical computer, or may be a virtual machine on a cloud.

That is, the device can be implemented by a program corresponding to processing performed by the device being executed by use of hardware resources such as a CPU and a memory built in the computer. The above program can be stored and distributed by being recorded in a computer-readable recording medium (portable memory or the like). Furthermore, the program can also be provided via a network such as the Internet or an electronic mail.

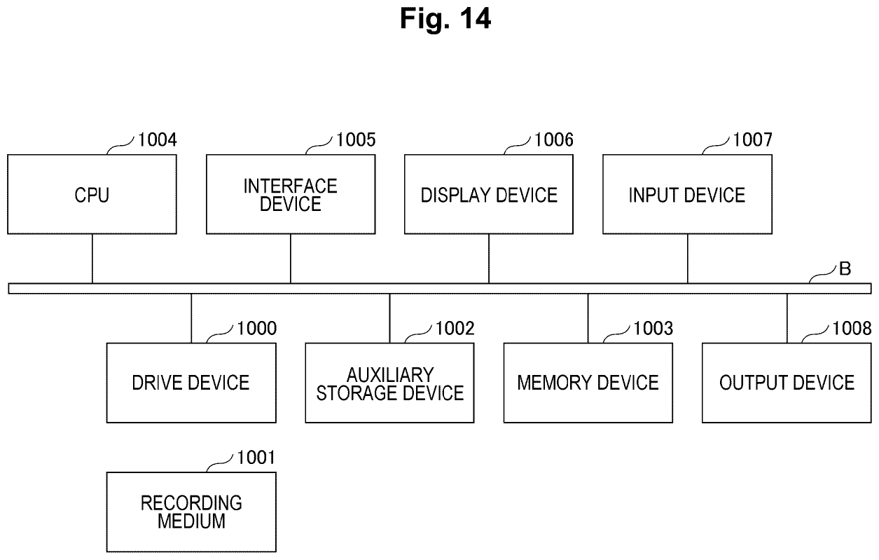

FIG. 14 is a diagram illustrating a hardware configuration example of the computer. The computer in FIG. 14 includes a drive apparatus 1000, an auxiliary storage apparatus 1002, a memory apparatus 1003, a CPU 1004, an interface apparatus 1005, a display apparatus 1006, an input apparatus 1007, an output apparatus 1008, and the like, which are connected to each other by a bus BS. The computer may further include a GPU.

A program for implementing processing in the computer is provided through a recording medium 1001 such as a CD-ROM or a memory card, for example. When the recording medium 1001 storing the program is set in the Drive apparatus 1000, the program is installed from the recording medium 1001 to the auxiliary storage apparatus 1002 via the Drive apparatus 1000. However, the program is not necessarily installed from the recording medium 1001, and may be downloaded from another computer via a network. The auxiliary storage apparatus 1002 stores the installed program, and also stores necessary files, data, and the like.

In a case where an instruction to start the program is given, the Memory apparatus 1003 reads the program from the auxiliary storage apparatus 1002 and stores the program. The CPU 1004 implements a function related to the generation apparatus 100 according to the program stored in the Memory apparatus 1003. The interface apparatus 1005 is used as an interface for connection to a network or the like. The display apparatus 1006 displays a graphical user interface (GUI) or the like according to the program. The input apparatus 1007 includes a keyboard and a mouse, buttons, a touch panel, or the like, and is used to input various operation instructions. The output apparatus 1008 outputs a calculation result.

### Summary of Embodiments, Effects, etc.

As described above, according to the technology described in the present embodiment, constraint words/phrases used for lexically constrained machine translation can be appropriately and automatically extracted with low noise. The technology described in the present embodiment enables accurate translation in lexically constrained machine translation.

Regarding the above embodiment, the following Supplementary Notes 1 and 2 are further disclosed.

### Supplementary Note 1

### Supplement 1

An extraction apparatus including:
a memory; and
at least one processor connected to the memory and causing, when instructions stored in the memory are executed by the processor, the extraction apparatus to:
divide both first information and a first sequence into unit information, the first information being in a dictionary that contains a set of pairs of first information and second information; and
extract, from the dictionary, a piece of second information paired with a piece of first information that matches the unit information derived from the first sequence, as constraint information to be used for generating a second sequence based on the first sequence.

### Supplement 2

The extraction apparatus according to Supplement 1 of Supplementary Note 1, in which the processor may further cause the extraction apparatus to delete a pair corresponding to a predetermined rule from the dictionary, and use a dictionary subjected to corresponding deletion processing.

### Supplement 3

The extraction apparatus according to Supplement 2 of Supplementary Note 1, in which the pair corresponding to the predetermined rule may be at least one of:
a pair including a word/phrase other than a noun or a word/phrase other than a noun phrase;
a pair including a word/phrase having a length of 1; or
a pair in which correspondence between first information and second information is not unique.

### Supplement 4

The extraction apparatus according to any one of Supplements 1 to 3 of Supplementary Note 1, in which the processor may further cause the extraction apparatus to search for a match between the unit information derived from the first sequence, and the piece of the first information, so as to resolve an ambiguity.

### Supplement 5

The extraction apparatus according to any one of Supplements 1 to 4 of Supplementary Note 1, in which the processor further may cause the extraction apparatus to:
generate display information for transmitting the constraint information to a display unit; and
receive constraint information obtained by making an addition or a modification to the constraint information displayed on the display unit.

### Supplement 6

A generation apparatus including:
a memory; and
at least one processor connected to the memory and causing, when instructions stored in the memory are executed by the processor, the generation apparatus to:
receive a first sequence as an input and extract constraint information based on the first sequence and a dictionary, the dictionary containing a set of pairs of first information and second information;
generate a second sequence based on the constraint information and the first sequence; and
generate display information for displaying the constraint information together with the second sequence such that the constraint information can be modified.

### Supplement 7

The generation apparatus according to Supplement 6 of Supplementary Note 1, in which the processor may further cause the generation apparatus to:
when constraint information, to which an addition or a modification has been made, is received, acquire a sequence generated based on the received constraint information; and
generate display information for displaying the acquired sequence.

### Supplement 8

The generation apparatus according to Supplement 6 or 7 of Supplementary Note 1, in which the processor may further cause the generation apparatus to generate, as a candidate for an addition, display information for displaying constraint information filtered based on a predetermined rule.

### Supplement 9

An extraction method executed by a computer, including:
dividing both first information and a first sequence into unit information, the first information being in a dictionary that contains a set of pairs of first information and second information; and
extracting, from the dictionary, a piece of second information paired with a piece of first information that matches the unit information derived from the first sequence, as constraint information to be used for generating a second sequence based on the first sequence.

### Supplement 10

A generation method executed by a computer, including:
receiving a first sequence as an input and extracting constraint information based on the first sequence and a dictionary, the dictionary containing a set of pairs of first information and second information;
generating a second sequence based on the constraint information and the first sequence; and
generating display information for displaying the constraint information together with the second sequence such that the constraint information can be modified.

### Supplement 11

A non-transitory storage medium that stores a program for causing a computer to function as the extraction apparatus according to any one of Supplements 1 to 5 of Supplementary Note 1.

### Supplementary Note 2

### Supplement 1

A generation apparatus for generating, from a first sequence and constraint information, a second sequence, the first sequence and the second sequence being sequences of different information, the generation apparatus including:
a memory; and
at least one processor connected to the memory and causing, when instructions stored in the memory are executed by the processor, the generation apparatus to:
receive a constraint information list as an input and output one or more subsets of pieces of constraint information in the constraint information list as one or more lexical constraints;
generate one or more candidates for the second sequence by using the first sequence and the lexical constraints; and
calculate a score of each of the one or more candidates for the second sequence, the score indicating appropriateness of each of the one or more candidates as the second sequence.

### Supplement 2

The generation apparatus according to Supplement 1 of Supplementary Note 2, in which the score may be calculated based on at least one of:
a likelihood output from a model used when generating the one or more candidates for the second sequence; or
a likelihood obtained from at least one candidate among the one or more candidates based on a re-ranking model.

### Supplement 3

The generation apparatus according to Supplement 1 or 2 of Supplementary Note 2, in which, when the constraint information list includes constraint information having an ambiguity, the one or more candidates for the second sequence may be generated by performing a lexically constrained beam search taking the ambiguity into account.

### Supplement 4

The generation apparatus according to any one of Supplements 1 to 3 of Supplementary Note 2, in which at least one piece of constraint information may be received as an input such that two or more ambiguities may be allowed, and the lexical constraints may be generated by retaining the ambiguities.

### Supplement 5

A generation method executed by a computer for generating, from constraint information and a first sequence that is a sequence of information, a second sequence that is a sequence of different information, the generation method including:
receiving a constraint information list as an input and outputting one or more subsets of pieces of constraint information in the constraint information list as one or more lexical constraints;
generating one or more candidates for the second sequence by using the first sequence and the lexical constraints; and
calculating a score of each of the one or more candidates for the second sequence, the score indicating appropriateness of each of the one or more candidates as the second sequence.

### Supplement 6

A non-transitory storage medium that stores a program for causing a computer to function as the generation apparatus according to any one of Supplements 1 to 4 of Supplementary Note 2.

Although the present embodiment has been described above, the present invention is not limited to specific embodiments, and various modifications and changes can be made within the scope of accompanying claims.

### REFERENCE SIGNS LIST

100 Generation apparatus
110 Input unit
120 Extraction unit
121 Filtering unit
122 Division unit
123 Constraint word/phrase extraction unit
130 Input generation unit
140 Sequence generation unit
141 Sequence conversion unit
142 Search unit
150 Re-ranking unit
160 Output unit
170 Display information generation unit
180 Modification unit
190 Generation unit
200 Bilingual dictionary DB
300 Model DB
400 Constraint word/phrase list DB
500 Display unit
1000 Drive apparatus
1001 Recording medium
1002 Auxiliary storage apparatus
1003 Memory apparatus
1004 CPU
1005 Interface apparatus
1006 Display apparatus
1007 Input apparatus
1008 Output apparatus

1-11. (canceled)

12. An extraction apparatus comprising:
a memory; and
at least one processor connected to the memory and causing, when instructions stored in the memory are executed by the processor, the extraction apparatus to:
divide both first information and a first sequence into unit information, the first information being in a dictionary that contains a set of pairs of first information and second information; and
extract, from the dictionary, a piece of second information paired with a piece of first information that matches the unit information derived from the first sequence, as constraint information to be used for generating a second sequence based on the first sequence.

13. The extraction apparatus according to claim 12, wherein the processor further causes the extraction apparatus to delete a pair corresponding to a predetermined rule from the dictionary, and uses a dictionary subjected to corresponding deletion processing.

14. The extraction apparatus according to claim 13, wherein the pair corresponding to the predetermined rule is at least one of:
a pair including a word/phrase other than a noun or a word/phrase other than a noun phrase;
a pair including a word/phrase having a length of 1; or
a pair in which correspondence between first information and second information is not unique.

15. The extraction apparatus according to claim 12, wherein the processor further causes the extraction apparatus to search for a match between the unit information derived from the first sequence, and the piece of the first information, so as to resolve an ambiguity.

16. The extraction apparatus according to claim 12, wherein the processor further causes the extraction apparatus to:
generate display information for transmitting the constraint information to a display unit; and
receive constraint information obtained by making an addition or a modification to the constraint information displayed on the display unit.

17. A generation apparatus including:
a memory; and
at least one processor connected to the memory and causing, when instructions stored in the memory are executed by the processor, the generation apparatus to:
receive a first sequence as an input and extract constraint information based on the first sequence and a dictionary, the dictionary containing a set of pairs of first information and second information;
generate a second sequence based on the constraint information and the first sequence; and
generate display information for displaying the constraint information together with the second sequence such that the constraint information can be modified.

18. The generation apparatus according to claim 17, wherein the processor further causes the generation apparatus to:
when constraint information, to which an addition or a modification has been made, is received, acquire a sequence generated based on the received constraint information; and
generate display information for displaying the acquired sequence.

19. The generation apparatus according to claim 17, wherein the processor further causes the generation apparatus to generate, as a candidate for an addition, display information for displaying constraint information filtered based on a predetermined rule.

20. An extraction method executed by a computer, including:
dividing both first information and a first sequence into unit information, the first information being in a dictionary that contains a set of pairs of first information and second information; and
extracting, from the dictionary, a piece of second information paired with a piece of first information that matches the unit information derived from the first sequence, as constraint information to be used for generating a second sequence based on the first sequence.

21. A non-transitory computer-readable storage medium storing instructions that, when executed by a computer, cause the computer to perform the extraction method of claim 20.
